(19) United States
(12) Patent Application Publication
(10) Pub. No.: US 2015/0255766 A1
(43) Pub. Date: Sep. 10, 2015

(54) SEALED SECONDARY BATTERY

(71) Applicant: SANYO Electric Co., Ltd., Moriguchi-shi, Osaka (JP)

(72) Inventors: Keisuke Shimizu, Osaka (JP); Tomohiko Yokoyama, Osaka (JP); Masato Fujikawa, Osaka (JP); Kyosuke Miyata, Osaka (JP); Koki Inoue, Osaka (JP)

(73) Assignee: SANYO ELECTRIC CO., LTD., Daito-shi, Osaka (JP)

(21) Appl. No.: 14/431,521

(22) PCT Filed: Sep. 18, 2013
(86) PCT No.: PCT/JP2013/005507

§ 371 Date: Mar. 26, 2015

(30) Foreign Application Priority Data
Oct. 23, 2012 (JP) 2012-233744

(51) Int. Cl. H01M 2/14; H01M 2/16; H01M 2/04; H01M 2/12; H01M 10/04

(52) U.S. Cl. CPC H01M 2/14; H01M 2/12; H01M 10/0431; H01M 2/04; H01M 2/0478; H01M 2/1653

(57) ABSTRACT

An object of the present invention is to safely discharge gases to the outside of a battery even when the gases are generated in a sealed secondary battery. In the sealed secondary battery according to the present invention, an electrode group (4) formed by winding a positive electrode plate (1) and a negative electrode plate (2) with a separator (3) interposed therebetween or formed by stacking the positive electrode plate (1) and the negative electrode plate (2) one on top of another with the separator (3) interposed therebetween is housed in a battery case (5). The sealed secondary battery includes an insulating plate (8) and a sealing body (10). The insulating plate (8) is disposed on an end surface of the electrode group (4) on an opening side of the battery case (5). The sealing body (10) seals the opening of the battery case and includes a cap (14). The cap (14) and the insulating plate (8) respectively have a first opening (14a) and a second opening (8a). When an area of the first opening (14a) is S1 and an area of the second opening (8a) is S2, S1 and S2 satisfy a relationship 1.2×S1+50 mm²<S2<5.0×S1+50 mm².

### TECHNICAL FIELD

The present invention relates to improvement of a sealed secondary battery equipped with a safety valve through which gases generated in the battery is discharged to the outside of the battery.

### BACKGROUND ART

A related-art sealed secondary battery (may be simply referred to as a “battery” hereafter) has the following structure: an electrode group, which is formed by winding a positive electrode plate and a negative electrode plate with a separator interposed therebetween or stacking the positive electrode plate and the negative electrode plate one on top of the other with the separator interposed therebetween, and an electrolyte solution is contained in a battery case. An opening of the battery case is sealed by a sealing body having a safety valve with a gasket interposed therebetween. An upper insulating plate is disposed at an upper end of the electrode group. Also, a lower insulating plate is disposed at a lower end of the electrode group.

When gases are generated in the battery by overheating and the pressure in the battery increases and exceeds a specified pressure, the safety valve operates so as to discharge the gases generated in the battery to the outside of the battery.

However, the electrode group of the related-art sealed secondary battery may be deformed by the increased pressure in the battery, and accordingly, the safety valve may be blocked. In such a case, the safety valve does not necessarily effectively function and the battery case may rupture.

A technique that addresses this is described in Patent Literature 1. According to the technique, a stacked plate, which is formed of phenol resin including an inorganic additive and a glass cross serving as a base material, is used as an upper insulating plate. Thus, the electrode group is prevented from being deformed, and accordingly, blocking of the safety valve is prevented.

### CITATION LIST

### Patent Literature

PTL 1: Japanese Published Unexamined Patent Application No. 2002-231314

### SUMMARY OF INVENTION

### Technical Problem

However, even by preventing the blocking of the safety valve so as to allow the safety valve to operate by using the technique as described in Patent Literature 1, there still is a possibility of rupture of the battery case when the gases generated in the battery cannot be quickly discharged to the outside of the battery.

In view of the above-described situation, an object of the present invention is to safely discharge the gases generated in the sealed secondary battery to the outside of the sealed secondary battery even when the gases are generated in the sealed secondary battery.

### Solution to Problem

In a sealed secondary battery according to the present invention, an electrode group formed by winding a positive electrode plate and a negative electrode plate with a separator interposed therebetween or formed by stacking the positive electrode plate and the negative electrode plate one on top of another with the separator interposed therebetween is housed in a battery case. The sealed secondary battery includes an insulating plate and a sealing body. The insulating plate is disposed on an end surface of the electrode group on an opening side of the battery case. The sealing body seals the opening of the battery case and includes a cap. The cap and the insulating plate respectively have a first opening and a second opening. When an area of the first opening is S1 and an area of the second opening is S2, S1 and S2 satisfy a relationship 1.2×S1+50 mm²<S2<5.0×S1+50 mm².

### Advantageous Effects of Invention

According to the present invention, even when the gases are generated in the battery, the gases generated in the battery can be safely discharged to the outside of the battery.

### BRIEF DESCRIPTION OF DRAWINGS

FIG. 1 is a sectional view illustrating the structure of a sealed secondary battery according to an embodiment of the present invention.

FIG. 2 is a view of the structure of a cap illustrating a planar structure in an upper part thereof and a sectional structure in a lower part thereof.

FIG. 3 is a plan view illustrating the structure of an insulating plate.

FIG. 4 illustrates the relationship between the area of openings of the cap and the area of openings of the insulating plate as well as results of the safety testing.

FIG. 5 is a sectional view illustrating the structure of the cap.

FIG. 6 is a plan view illustrating the structure of the insulating plate.

### DESCRIPTION OF EMBODIMENTS

An embodiment of the present invention will be described below with reference to the drawings. It should be understood that the embodiment hereafter is only an exemplary embodiment of the present invention and does not limit the present invention. It should be understood that a variety of variants of or changes to the present invention is possible without departing from the gist of the present invention, and examples of the variants and the changes are within the scope of the present invention. In the drawings, elements are drawn with dimension ratios suitable for illustration, and the dimension ratios used for the illustration may be different from actual dimension ratios.

### EMBODIMENT

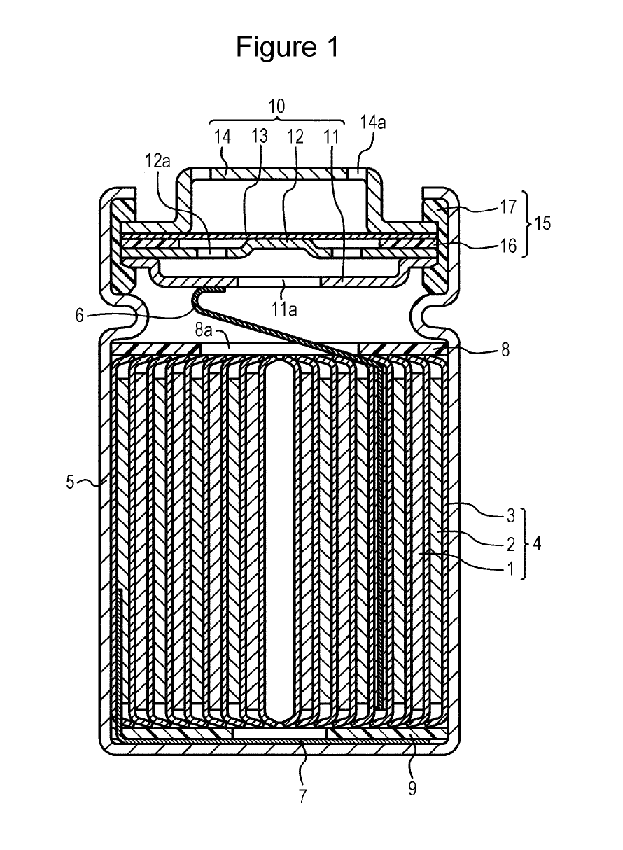

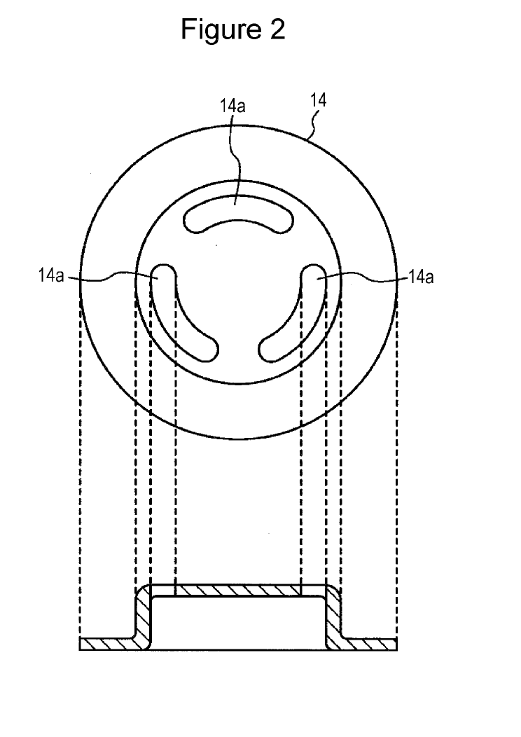

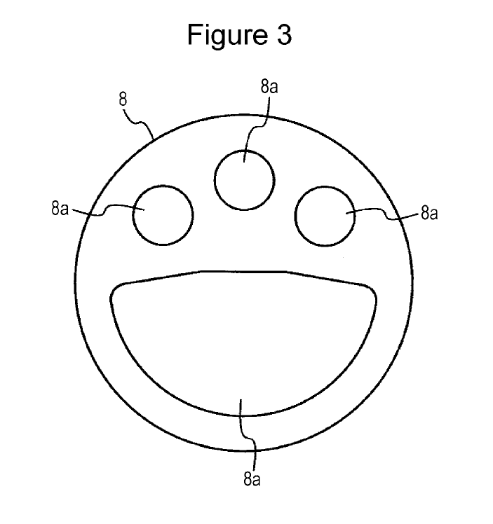

A sealed secondary battery according to an embodiment of the present invention is described below with reference to FIGS. 1, 2, and 3. FIG. 1 is a sectional view illustrating the structure of a sealed secondary battery according to the present embodiment. FIG. 2 illustrates the structure of a cap. An upper part of FIG. 2 illustrates a planar structure and a lower part of FIG. 2 illustrates a sectional structure. FIG. 3 is a plan view illustrating the structure of an insulating plate. The present embodiment is described with a specific example in which a lithium-ion secondary battery is used as the sealed secondary battery.

As illustrated in FIG. 1, an electrode group 4, which is formed by winding a positive electrode plate 1 and a negative electrode plate 2 with a separator 3 interposed therebetween, and an electrolyte solution is contained in a battery case 5. Although detailed illustration is omitted in FIG. 1, the positive electrode plate 1 includes a positive electrode collector and a positive electrode mixture layer. The positive electrode mixture layer is formed on the positive electrode collector and includes a positive electrode active material. The negative electrode plate 2 includes a negative electrode collector and a negative electrode mixture layer. The negative electrode mixture layer is formed on the negative electrode collector and includes a negative electrode active material.

The positive electrode plate 1 is connected to a sealing body 10 (specifically, a terminal plate 11 included in the sealing body 10) through a positive electrode lead 6. The negative electrode plate 2 is connected to a bottom portion of the battery case 5 through a negative electrode lead 7.

An insulating plate 8 is disposed at an upper end of the electrode group 4 (an end of the electrode group 4 on an opening side of the battery case 5). An insulating plate 9 is disposed at a lower end of the electrode group 4 (an end of the electrode group 4 on the bottom portion side of the battery case 5).

The opening of the battery case 5 is sealed by the sealing body 10 with a gasket 15 interposed therebetween.

The sealing body 10 includes the terminal plate 11, a valve body 12, a valve body 13, and a cap 14. The terminal plate 11 is disposed above the insulating plate 8. The valve body 12 is disposed on the terminal plate 11. The valve body 13 is disposed on the valve body 12. The cap 14 is disposed on the valve body 13 and also functions as a positive electrode terminal. The gasket 15 includes an inner gasket 16, which is interposed between the valve body 12 and valve body 13, and an outer gasket 17, which is interposed between the sealing body 10 and the battery case 5.

As illustrated in FIGS. 1 and 2, the cap 14 has openings 14a (first opening) that communicate with the outside of the battery. As illustrated in FIG. 1, the valve body 12 and the terminal plate 11 respectively have openings 12a and an opening 11a. As illustrated in FIGS. 1 and 3, the insulating plate 8 has openings 8a (second opening).

As illustrated in FIGS. 1 and 2, the cap 14 has a circumferential portion that is in contact with the valve body 13 and a projecting portion that projects from the circumferential portion. The openings 14a are formed in an upper surface portion of the projecting portion.

When gases are generated in the battery by, for example, overheating, the gases generated in the battery are discharged to the outside of the battery as follows. That is, when the gases are generated in the battery, and accordingly, the pressure in the battery increases and exceeds a specified pressure, the valve body 13 breaks. This allows the gases generated in the battery to be discharged to the outside of the battery through the openings 8a of the insulating plate 8, the opening 11a of the terminal plate 11, the openings 12a of the valve body 12, a broken part of the valve body 13, and the openings 14a of the cap 14.

As has been mentioned, even when the safety valve operates, the battery case may rupture. The inventors devoted investigation for the causes of this, and, as a result, found the following.

In the case where the terminal plate 11, the valve body 12, and the valve body 13 are formed of, for example, aluminum (Al), and the cap 14 is formed of, for example, iron (Fe), since the melting point of Al is generally lower than the melting point of Fe, the terminal plate 11, the valve body 12, and the valve body 13 melt due to high-temperature gases generated in the battery, and accordingly, the area of the opening 11a of the terminal plate 11, the area of the openings 12a of the valve body 12, and the area of the broken part of the valve body 13 increase. In contrast, since the melting point of Fe is generally higher than the melting point of Al, the cap 14 is unlikely to melt and the area of the openings 14a of the cap 14 is unlikely to increase due to the high-temperature gases generated in the battery.

From the above-described points, the inventors found the following. That is, a discharging capacity of the sealing body 10 largely depends on the area of the openings 14a of the cap 14. A discharge capacity of the insulating plate 8 depends on the area of the openings 8a of the insulating plate 8.

Herein, the “area of the openings 14a” refers to a so-called horizontal projection area of the openings 14a. Likewise, the “area of the openings 8a” herein refers to a so-called horizontal projection area of the openings 8a. The horizontal projection areas of the openings 8a and the openings 14a refer to the areas when the openings 8a and the openings 14a are seen from right above (right above along a winding axis of the electrode group 4).

As illustrated in FIG. 2, when a plurality of the openings 14a of the cap 14 are provided, “the area of the openings 14a of the cap 14” herein refers to the sum of the areas of the plurality of openings 14a. Likewise, as illustrated in FIG. 3, when a plurality of the openings 8a of the insulating plate 8 are provided, “the area of the openings 8a of the insulating plate 8” herein refers to the sum of the areas of the plurality of openings 8a.

Furthermore, the inventors found the following. When the area of the openings 14a of the cap 14 and the area of the openings 8a of the insulating plate 8 are independently determined without considering the discharge capacity of the sealing body 10 and the discharge capacity of the insulating plate 8, the gases generated in the battery may not be safely discharged to the outside of the battery. For example, when the discharge capacity of the sealing body 10 is significantly lower than the discharge capacity of the insulating plate 8, an excessive pressure may act on the sealing body 10, thereby ejecting the sealing body 10 from the battery. Conversely, when, for example, the discharge capacity of the insulating plate 8 is significantly lower than the discharge capacity of the sealing body 10, a pressure in a portion of the battery case 5 below the insulating plate 8 may excessively increase, thereby causing the battery case 5 to rupture.

The claimed invention has been made in accordance with the above-described findings by the inventors. The claimed invention safely discharges the gases generated in the battery to the outside of the battery even when the gases are generated by overheating in the battery by determining the relationship between the area of the openings 14a of the cap 14 and the area of the openings 8a of the insulating plate 8.

In order to determine the above-described relationship, the inventors produced a plurality of batteries and performed safety testing. The plurality of produced batteries have the structure similar to that of the sealed secondary battery illustrated in FIG. 1. However, the areas of the openings 14a of the caps 14 and/or the areas of the openings 8a of the insulating plates 8 of the plurality of produced batteries are different from one another.

### <Production of the Batteries>

Each of the batteries was produced as follows.

The positive electrode plate 1 was produced as follows. A positive electrode active material made of lithium nickelate (LiNiO₂), a binder made of polyvinylidene fluoride (PVDF), and a conductant agent made of acetylene black were dispersed in a solvent so as to prepare positive electrode mixture slurry. After that, the positive electrode mixture slurry was applied onto the positive electrode collector formed of aluminum, dried, and rolled. Thus, the positive electrode plate 1, in which the positive electrode mixture layer was formed on the positive electrode collector, was produced.

The negative electrode plate 2 was produced as follows. A negative electrode active material made of graphite and a binder made of styrene-butadiene rubber were dispersed in a solvent so as to prepare negative electrode mixture slurry. After that, the negative electrode mixture slurry was applied onto the negative electrode collector formed of copper, dried, and rolled. Thus, the negative electrode plate 2, in which the negative electrode mixture layer was formed on the negative electrode collector, was produced.

Next, the positive electrode plate 1 and the negative electrode plate 2 were wound together with the separator 3 formed of polyethylene interposed therebetween. Thus, the electrode group 4 was produced.

Next, the insulating plate 8 was disposed on the upper end of the electrode group 4, and the insulating plate 9 was disposed on the lower end of the electrode group 4. After that, the electrode group 4 was inserted into the cylindrical battery case 5 having an outer diameter of 18 mm, the positive electrode lead 6 was connected to the terminal plate 11 of the sealing body 10, and the negative electrode lead 7 was connected to the bottom portion of the battery case 5. After that, the electrolyte solution, which was prepared by dissolving an electrolyte made of LiPF₆ into a solvent made of ethylene carbonate, was poured into the battery case 5. After that, a step portion was formed in a side surface portion of the battery case 5, and the sealing body 10 was disposed on the step portion with the gasket 15 interposed therebetween. After that, an opening end portion of the battery case 5 was swaged to a circumferential portion of the sealing body 10 with the gasket 15 interposed therebetween, so that an opening of the battery case 5 was sealed.

The insulating plate 8 was formed of glass phenol resin having a thickness of 0.3 mm. The terminal plate 11 was formed of aluminum having a thickness of 0.4 mm. The valve body 12 was formed of aluminum having a thickness of 0.15 mm. The valve body 13 was formed of aluminum having a thickness of 0.15 mm. The cap 14 was formed of iron having a thickness of 0.4 mm.

### <Safety Testing>

Safety testing was performed by applying heat of 200° C. to each of the batteries from the outside of the battery so as to force the battery to overheat and checking whether the sealing body 10 shattered and whether the battery case 5 ruptured.

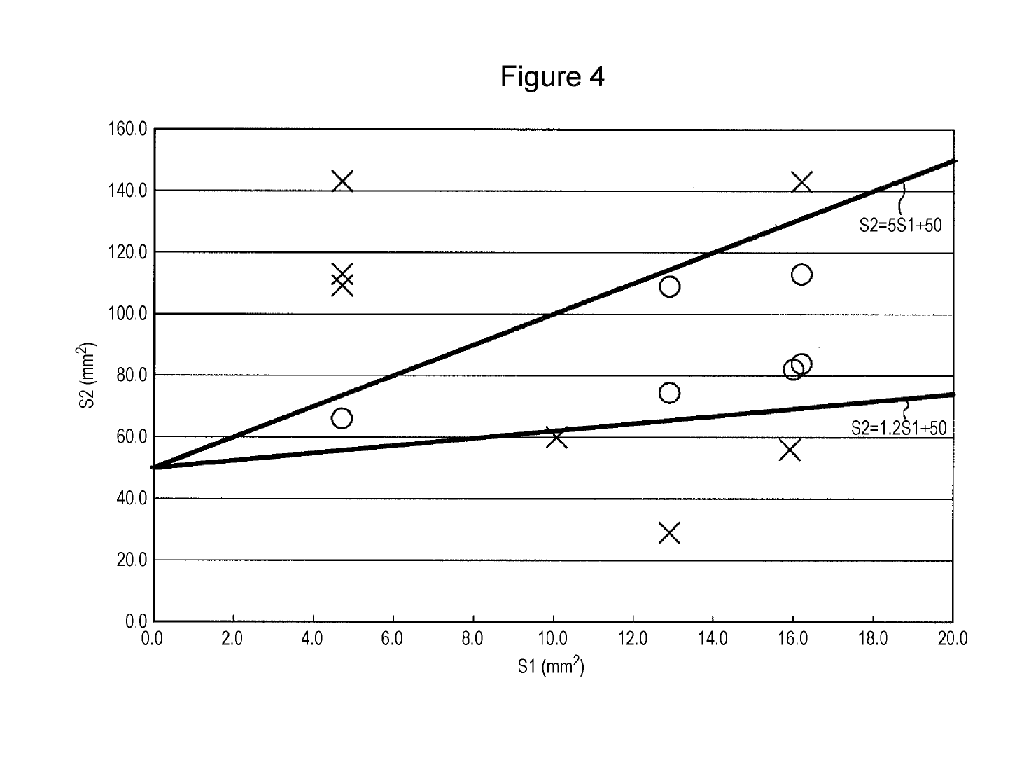

FIG. 4 illustrates the relationship between the area of the openings 14a of the cap 14 and the area of the openings 8a of the insulating plate 8 as well as results of the safety testing. The horizontal axis illustrated in FIG. 4 represents “S1”, which is the area of the openings 14a of the cap 14. The vertical axis illustrated in FIG. 4 represents “S2”, which is the area of the openings 8a of the insulating plate 8. In FIG. 4, circle marks represent the batteries in which the sealing bodies 10 did not shatter and the battery cases 5 did not rupture. In FIG. 4, X marks represent the batteries in which the sealing bodies 10 shattered or the battery cases 5 ruptured.

As illustrated in FIG. 4, when S1 and S2 of the batteries satisfied the following relationship, the sealing bodies 10 of these batteries did not shatter and the battery cases 5 of these batteries did not rupture: 1.2×S1+50 mm²<S2<5.0×S1+50 mm². In contrast, when S2 was equal to or more than 5.0×S1+50 mm², the sealing bodies 10 shattered. When S2 was equal to or less than 1.2×S1+50 mm², the battery cases 5 ruptured.

As can be seen from FIG. 4, when S1 and S2 satisfy the relationship 1.2×S1+50 mm²<S2<5.0×S1+50 mm², the gases generated in each of the batteries can be safely discharged to the outside of the battery without causing the sealing body 10 to shatter and the battery case 5 to rupture.

When the cross-sectional area of the battery case 5 is S, S2/S is preferably equal to or more than 0.2. The reason of this is as follows: Here, “the cross-sectional area of the battery case 5” refers to the area of the battery case 5 cut in a direction (horizontal direction in the page of FIG. 1) perpendicular to the winding axis direction of the electrode group 4 (vertical direction in the page of FIG. 1).

As has been described, the discharge capacity of the insulating plate 8 depends on the area S2 of the openings 8a of the insulating plate 8. Furthermore, the discharge capacity of the insulating plate 8 depends not only on the area S2 of the openings 8a of the insulating plate 8 but also on the cross-sectional area S of the battery case 5 as described below.

The gases generated in the battery (specifically, the gases generated in the portion of the battery case 5 below the insulating plate 8) are discharged to the outside of the battery through the openings 8a of the insulating plate 8. Thus, the discharge capacity of the insulating plate 8 is determined in accordance with the ratio (S2/S) of the area S2 of the openings 8a of the insulating plate 8 occupying the cross-sectional area S of the battery case 5 to the cross-sectional area S of the battery case 5. When the S2/S is equal to or more than 0.2, the gases generated in the battery can pass through the openings 8a of the insulating plate 8 without causing the battery case 5 to rupture. Specifically, in the case of each of the batteries illustrated in FIG. 4, the cross-sectional area of the cylindrical battery case 5 having an outer diameter of 18 mm is about 254.34 mm² (9 mm×9 mm×3.14). Thus, the area S2 of the openings 8a of the insulating plate 8 is preferably equal to or more than 50.868 mm² (254.34 mm²×0.2).

According to the present embodiment, S1 and S2 satisfy the relationship 1.2×S1+50 mm²<S2<5.0×S1+50 mm². Thus, even when the gases are generated in the battery by overheating, the gases generated in the battery can be safely discharged to the outside of the battery.

The gases generated in the battery include a gas generated by thermal decomposition reaction of the positive electrode active material. In general, the positive electrode active material made of an Li—Ni based composite oxide such as, for example, LiNiO₂ starts the thermal decomposition reaction at a lower temperature than the temperature at which the positive electrode active material made of an Li—Co based composite oxide such as, for example, LiCoO₂ starts the thermal decomposition reaction, and accordingly, generates a larger amount of the gas in the battery than the positive electrode active material made of an Li—Co based composite oxide. However, when S1 and S2 satisfy the relationship 1.2×S1+50 mm²<S2<5.0×S1+50 mm², the gases generated in the batteries can be safely discharged to the outside of the battery even when the positive electrode active material made of an Li—Ni based composite oxide is used.

Furthermore, as illustrated in FIG. 2, the openings 14a are formed not in a side surface portion of the projecting portion of the cap 14 but in the upper surface portion of the projecting portion of the cap 14. Thus, for example, in a battery pack that includes a plurality of the sealed secondary batteries according to the present embodiment, even when the high-temperature gases are generated by overheating in a particular battery among the plurality of batteries, the high-temperature gases can be discharged while suppressing a situation in which the high-temperature gases are brought into contact with the other batteries adjacent to the particular battery. Thus, heating of the other batteries due to contact with the high-temperature gases can be suppressed.

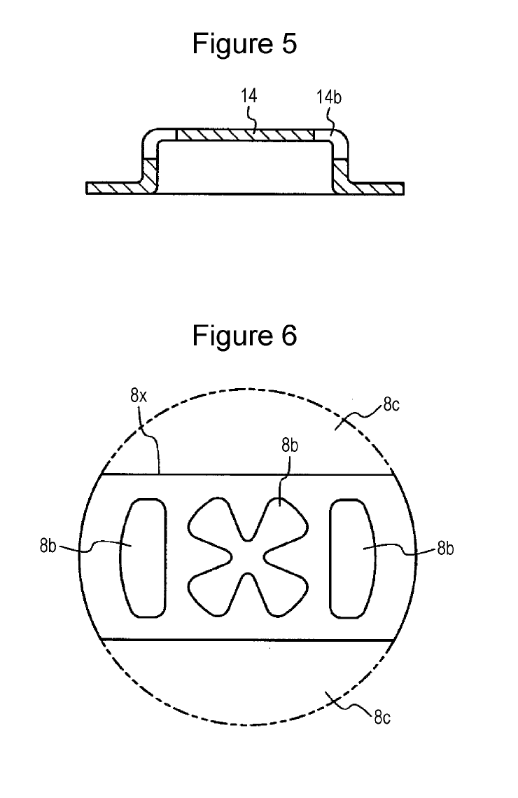

Although the present embodiment has been described with the specific example in which the cap 14 has a structure illustrated in FIG. 2, the present invention is not limited to this. For example, the cap may have a structure illustrated in FIG. 5.

In the case of the present embodiment, as illustrated in FIG. 2, the openings 14a having I-shaped sections are formed only in the upper surface portion of the projecting portion of the cap 14. Instead, as illustrated in FIG. 5, openings 14b having L-shaped sections may be formed in the upper and side surface portions of the projecting portion of the cap 14.

Although the present embodiment has been described with the specific example in which the insulating plate 8 has a structure illustrated in FIG. 3, the present invention is not limited to this. For example, the insulating plate may have a structure illustrated in FIG. 6.

In the case of the present embodiment, as illustrated in FIG. 3, the insulating plate 8 has a circular planar shape. As illustrated in FIG. 1, a circumferential end surface of the insulating plate 8 having a circular planar shape is in contact with an inner circumferential surface of the cylindrical battery case 5. The area S2 of the openings 8a of the insulating plate 8 is the sum of the areas of four openings 8a formed in the insulating plate 8.

Alternatively, as illustrated in FIG. 6, an insulating plate 8x may have a planar shape formed by partially cutting a circle instead of a circular shape. Out of four end surfaces of the insulating plate 8x, two end surfaces may be in contact with parts of the inner circumferential surface of the cylindrical battery case 5 while two other end surfaces that face each other are not necessarily in contact with the inner circumferential surface of the battery case 5. In this case, the area S2 of openings 8b and 8c of the insulating plate 8x is the sum of the areas of three openings 8b formed in the insulating plate 8x and the areas of two openings 8c formed between the two facing end surfaces and the inner circumferential surface of the battery case 5 (see dotted lines illustrated in FIG. 6).

As can be seen from FIGS. 2 and 5, the openings of the cap may have arbitrary shapes. As can be seen from FIGS. 3 and 6, the openings of the insulating plate may have arbitrary shapes. It is sufficient that at least one opening be formed in the cap and at least one opening be formed in the insulating plate. It is sufficient that the area S1 of the openings of the cap and the area S2 of the openings of the insulating plate satisfy the relationship 1.2×S1+50 mm²<S2<5.0×S1+50 mm². As long as the area S1 of the openings of the cap and the area S2 of the openings of the insulating plate satisfy the relationship 1.2×S1+50 mm²<S2<5.0×S1+50 mm², the openings of the cap and the insulating plate may have any shapes, any number of the openings may be formed in the cap, and any number of the openings may be formed in the insulating plate.

Although the present embodiment has been described with the specific example in which, as illustrated in FIG. 1, the sealing body 10 includes the terminal plate 11, two valve bodies 12 and 13, and the cap 14, the present invention is not limited to this. For example, the sealing body may include the terminal plate, a single valve body, and the cap. It is sufficient that the sealing body include at least one valve body. In this case, it is sufficient that the at least one valve body do not have an opening and the at least one valve body break when the pressure in the battery exceeds a specified pressure.

Although the present embodiment has been described with the specific example in which the cap 14 is formed of iron, the present invention is not limited to this. For example, the cap may be formed of stainless steel (SUS304).

Although the present embodiment has been described with the specific example in which the lithium-ion secondary battery is used as the sealed secondary battery, the present invention is not limited to this.

Although the present embodiment has been described with the specific example in which the cylindrical secondary battery is used as the sealed secondary battery, the present invention is not limited to this. For example, a rectangular secondary battery may be used.

Although the present embodiment has been described with the specific example in which, as illustrated in FIG. 1, the electrode group 4 formed by winding together the positive electrode plate 1 and the negative electrode plate 2 with the separator 3 interposed therebetween is used, the present invention is not limited to this. For example, an electrode group including the positive electrode plate and the negative electrode plate stacked one on top of the other with the separator interposed therebetween may be used.

### INDUSTRIAL APPLICABILITY

The present invention is useful for the sealed secondary battery that can safely discharge the gases generated in the battery to the outside of the battery even when the gases are generated in the battery.

### REFERENCE SIGNS LIST

1 positive electrode plate
2 negative electrode plate
3 separator
4 electrode group
5 battery case
6 positive electrode lead
7 negative electrode lead
8 insulating plate
8a opening (second opening)
9 insulating plate
10 sealing body
11 terminal plate
11a opening
12 valve body
12a opening
13 valve body
14 cap
14a opening (first opening)
15 gasket
16 inner gasket
17 outer gasket

1. A sealed secondary battery in which an electrode group formed by winding a positive electrode plate and a negative electrode plate with a separator interposed therebetween or formed by stacking the positive electrode plate and the negative electrode plate one on top of another with the separator interposed therebetween is housed in a battery case, the sealed secondary battery comprising:
an insulating plate disposed on an end surface of the electrode group on an opening side of the battery case; and
a sealing body that seals the opening of the battery case and that includes a cap,
wherein the cap and the insulating plate respectively have a first opening and a second opening, and
wherein, when an area of the first opening is S1 and an area of the second opening is S2, S1 and S2 satisfy a relationship 1.2×S1+50 mm²<S2<5.0×S1+50 mm².

2. The sealed secondary battery according to claim 1,
wherein the sealing body includes a terminal plate disposed above the insulating plate, a valve body disposed on the terminal plate, and the cap disposed on the valve body, and
wherein one of the positive electrode plate and the negative electrode plate is connected to the terminal plate through a lead.

3. The sealed secondary battery according to claim 2,
wherein a melting point of the cap is higher than a melting point of the terminal plate and a melting point of the valve body.

4. The sealed secondary battery according to claim 3,
wherein the cap is formed of iron or stainless steel, and
wherein the terminal plate and the valve body are formed of aluminum.

5. The sealed secondary battery according to claim 1,
wherein the cap has a projecting portion, and
wherein the first opening is formed in an upper surface portion of the projecting portion.

6. The sealed secondary battery according to claim 1,
wherein, when a cross-sectional area of the battery case is S, S2/S is equal to or more than 0.2.

7. The sealed secondary battery according to claim 1,
wherein the positive electrode plate includes a positive electrode collector and a positive electrode mixture layer that is formed on the positive electrode collector and that includes a positive electrode active material, and
wherein the positive electrode active material includes nickel.

8. The sealed secondary battery according to claim 1,
wherein the insulating plate is formed of glass phenol resin.
